(19) United States
(12) Patent Application Publication
(10) Pub. No.: US 2022/0250363 A1
(43) Pub. Date: Aug. 11, 2022

(54) HEAT RESISTANT POLYETHYLENE MULTILAYER FILMS FOR HIGH SPEED FLEXIBLE PACKAGING LINES

(71) Applicant: Dow Global Technologies LLC, Midland, MI (US)

(72) Inventors: Edward L. Lee, Singapore (SG); Hwee Tatz Thai, Singapore (SG); Wu Aik Yee, Singapore (SG); Hwee Lun Goh, Singapore (SG)

(73) Assignee: Dow Global Technologies LLC, Midland, MI (US)

(21) Appl. No.: 17/622,521

(22) PCT Filed: Jun. 24, 2020
(86) PCT No.: PCT/US2020/039233

§ 371 Date: Dec. 23, 2021

Related U.S. Application Data
(60) Provisional application No. 62/867,981, filed on Jun. 28, 2019.

(51) Int. Cl. B32B 27/08; B32B 27/30

(52) U.S. Cl. CPC B32B 27/08; B32B 27/306; B32B 27/308; B32B 2250/05; B32B 2439/70; B32B 2307/306; B32B 2307/31; B32B 2307/406; B32B 2270/00

(57) ABSTRACT

Multilayer films comprising an outer layer, a sealant layer, and a tie layer positioned between the outer layer and the sealant layer are provided. The outer layer includes one or more of a first polyethylene having a density of greater than 0.945 g/cc and a polyethylene having a density of from 0.910 to 0.940 g/cc. The sealant layer includes one or more of at least one ethylene acid copolymer having from 0.1 to 10 wt % neutralized with a cation source, a polyethylene plastomer having a density below 0.910 g/cc, and an ethylene based polymer having a melting point Tm (DSC) of less than or equal to 108° C. The tie layer includes an adhesive resin selected from the group consisting of anhydride grafted ethylene based polymer, ethylene acid copolymer, and ethylene vinyl acetate.

### CROSS REFERENCE TO RELATED APPLICATIONS

This application claims priority to U.S. Provisional Patent Application No. 62/867,981, filed on Jun. 28, 2019, the entire disclosure of which is hereby incorporated by reference.

### TECHNICAL FIELD

Embodiments of the present disclosure are generally related to multilayer films, and are more particularly related to multilayer films including polyethylene.

### BACKGROUND

Multilayer films can include films such as cast films or blown films, which may be suitable for flexible packages such as sachets or pouches for various consumer products. Conventional laminates used in such applications typically include one or more layers of polyethylene terephthalate (PET) or biaxially oriented polypropylene (BOPP) laminated to a polyethylene sealant substrate. Although such structures are printable, heat-resistant, and able to withstand high temperature sealing for good seal integrity, such laminates are unable to be recycled.

Although mono-material polyethylene multilayer films have been introduced in order to address the recyclability issue, they typically lack the heat resistance needed for use in high temperature sealing high speed packaging machines, which can result in distorted printing. Additionally or alternatively, such films can have limited stiffness, scuff resistance, tensile strength, and/or gloss. Moreover, the use of laminating adhesives to enable the adhesion of the package to ink, can limit recyclability.

Accordingly, there remains a need for mono-material polyethylene multilayer films having suitable heat resistance.

### SUMMARY

The present compositions meet these needs by providing films having a heat resistance layer to protect against shrinkage or distortion during heat sealing and a tie layer that adheres the heat resistance layer to ink, sealant layers, and/or other polyethylene films without the need for laminating adhesives.

According to at least one embodiment of the present disclosure, a multilayer film comprises an outer layer, a sealant layer, and a tie layer positioned between the outer layer and the sealant layer. The outer layer comprises one or more of a first polyethylene having a density of greater than 0.945 g/cc and a second polyethylene having a density of from 0.910 to 0.940 g/cc. The sealant layer comprises one or more of at least one ethylene acid copolymer having from 0.1 to 10 wt % neutralized with a cation source, a polyethylene plastomer having a density below 0.910 g/cc, and an ethylene based polymer having a melting point Tm (DSC) of less than or equal to 108° C. The tie layer includes an adhesive resin selected from the group consisting of anhydride grafted ethylene based polymer, ethylene acid copolymer, and ethylene vinyl acetate.

According to another embodiment of the present disclosure, the outer layer comprises the first polyethylene, and the multilayer film further comprises a core layer comprising biaxially oriented polyethylene having a density of from 0.910 to 0.940 g/cc, wherein the tie layer is disposed between the core layer and the sealant layer.

According to another embodiment of the present disclosure, the multilayer film comprises the multilayer film according to the previous embodiment, wherein the multilayer film further comprises a second tie layer disposed between the core layer and the outer layer.

According to another embodiment of the present disclosure, the multilayer film comprises the multilayer film according to any of the previous embodiments, wherein the tie layer further comprises at least one of linear low density polyethylene (LLDPE) or low density polyethylene (LDPE).

According to another embodiment of the present disclosure, the multilayer film comprises the multilayer film according to any of the previous embodiments, wherein the multilayer film is a blown film or cast film.

According to another embodiment of the present disclosure, the multilayer film comprises the multilayer film according to any of the previous embodiments, wherein the multilayer film is formed by thermal lamination or by extrusion lamination and coating.

According to another embodiment of the present disclosure, the multilayer film comprises the multilayer film according to any of the previous embodiments, wherein the outer layer comprises biaxially oriented polyethylene (BOPE) or machine-direction oriented polyethylene (MDO).

According to another embodiment of the present disclosure, the multilayer film comprises the multilayer film according to any of the previous embodiments, wherein the outer layer comprises medium density polyethylene (MDPE).

According to another embodiment of the present disclosure, the multilayer film comprises the multilayer film according to any of the previous embodiments, wherein the ethylene-based polymer of the sealant layer has a Tm (DSC) of greater than 70° C. and less than 99° C.

According to another embodiment of the present disclosure, the multilayer film comprises the multilayer film according to any of the previous embodiments, wherein the multilayer film is a laminate free of solvent-based adhesives, solventless adhesives, and water-borne laminating adhesives.

According to another embodiment of the present disclosure, the multilayer film comprises the multilayer film according to any of the previous embodiments, wherein the multilayer film exhibits a shrinkage of less than 5% in the transverse direction at 125° C., 40 PSI jaw pressure, and 0.5 seconds dwell time.

According to another embodiment of the present disclosure, the multilayer film comprises the multilayer film according to any of the previous embodiments, wherein the multilayer film exhibits a shrinkage of less than 10% in the machine direction at 125°, 40 PSI jaw pressure, and 0.5 seconds dwell time.

According to another embodiment of the present disclosure, the multilayer film comprises the multilayer film according to any of the previous embodiments, wherein the multilayer film exhibits a seal strength of 25 N/25 mm or greater at 125° C. as measured in accordance with ASTM F1921.

According to another embodiment of the present disclosure, the multilayer film comprises the multilayer film according to any of the previous embodiments, wherein the multilayer film exhibits a heat seal initiation temperature (HSIT) of less than 120° C. at 5 N.

According to another embodiment of the present disclosure, the multilayer film comprises the multilayer film according to any of the previous embodiments, wherein the multilayer film exhibits a gloss at 45° of greater than 25, as measured in accordance with ASTM D2457-08/ASTM D1003-01.

According to another embodiment of the present disclosure, the multilayer film comprises the multilayer film according to any of the previous embodiments, wherein the sealant layer comprises at least one ethylene acid copolymer having from 0.1 to 10 wt % neutralized with the cation source, which may comprise sodium salt, zinc salt, or combinations thereof.

According to another embodiment of the present disclosure, the multilayer film comprises the multilayer film according to any of the previous embodiments, further comprising a print layer.

According to another embodiment of the present disclosure, an article comprises the multilayer film according to any of the previous embodiments, wherein the article is a pouch.

These and other embodiments are described in more detail in the following Detailed Description and the Drawings.

### BRIEF SUMMARY OF THE DRAWINGS

FIG. 1 is a heat seal strength curve depicting one or more sample embodiments of the present disclosure.

FIG. 2 is another heat seal strength curve depicting one or more sample embodiments of the present disclosure.

### DETAILED DESCRIPTION

Specific embodiments of the present application will now be described. The disclosure may, however, be embodied in different forms and should not be construed as limited to the embodiments set forth in this disclosure. Rather, these embodiments are provided so that this disclosure will be thorough and complete, and will fully convey the scope of the subject matter to those skilled in the art.

### Definitions

The term “polymer” refers to a polymeric compound prepared by polymerizing monomers, whether of the same or a different type. The generic term polymer thus embraces the term “homopolymer,” usually employed to refer to polymers prepared from only one type of monomer as well as “copolymer” which refers to polymers prepared from two or more different monomers. The term “interpolymer,” as used herein, refers to a polymer prepared by the polymerization of at least two different types of monomers. The generic term interpolymer thus includes copolymers, and polymers prepared from more than two different types of monomers, such as terpolymers.

“Polyethylene” or “ethylene-based polymer” shall mean polymers comprising greater than 50% by mole of units which have been derived from ethylene monomer. This includes polyethylene homopolymers or copolymers (meaning units derived from two or more comonomers). Common forms of polyethylene known in the art include Low Density Polyethylene (LDPE); Linear Low Density Polyethylene (LLDPE); Ultra Low Density Polyethylene (ULDPE); Very Low Density Polyethylene (VLDPE); Medium Density Polyethylene (MDPE); and High Density Polyethylene (HDPE).

The term “LDPE” may also be referred to as “high pressure ethylene polymer” or “highly branched polyethylene” and is defined to mean that the polymer is partly or entirely homopolymerized or copolymerized in autoclave or tubular reactors at pressures above 14,500 psi (100 MPa) with the use of free-radical initiators, such as peroxides (see for example U.S. Pat. No. 4,599,392, which is hereby incorporated by reference). LDPE resins typically have a density in the range of 0.916 to 0.935 g/cm.

The term “LLDPE” includes resin made using Ziegler-Natta catalyst systems as well as resin made using single-site catalysts, including, but not limited to, bis-metallocene catalysts (sometimes referred to as “m-LLDPE”) and constrained geometry catalysts, and resin made using post-metallocene, molecular catalysts. LLDPE includes linear, substantially linear or heterogeneous polyethylene copolymers or homopolymers. LLDPEs contain less long chain branching than LDPEs and includes the substantially linear ethylene polymers which are further defined in U.S. Pat. Nos. 5,272,236, 5,278,272, 5,582,923 and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. No. 3,914,342 or 5,854,045). The LLDPE resins can be made via gas-phase, solution-phase or slurry polymerization or any combination thereof, using any type of reactor or reactor configuration known in the art.

The term “MDPE” refers to polyethylenes having densities from 0.926 to 0.945 g/cc. “MDPE” is typically made using chromium or Ziegler-Natta catalysts or using single-site catalysts including, but not limited to, bis-metallocene catalysts and constrained geometry catalysts.

The term “HDPE” refers to polyethylenes having densities greater than about 0.945 g/cc, which are generally prepared with Ziegler-Natta catalysts, chrome catalysts or single-site catalysts including, but not limited to, bis-metallocene catalysts and constrained geometry catalysts.

The term “ULDPE” refers to polyethylenes having densities of 0.880 to 0.909 g/cc, which are generally prepared with Ziegler-Natta catalysts, single-site catalysts including, but not limited to, bis-metallocene catalysts and constrained geometry catalysts, and post-metallocene, molecular catalysts. The term “propylene-based polymer,” as used herein, refers to a polymer that comprises, in polymerized form, refers to polymers comprising greater than 50% by weight of units which have been derived from propylene monomer. This includes propylene homopolymer, random copolymer polypropylene, impact copolymer polypropylene, propylene/α-olefin interpolymer, and propylene/α-olefin copolymer. These polypropylene materials are generally known in the art.

“Multilayer film” means any structure having more than one layer. For example, the multilayer structure may have two, three, four, five or more layers. A multilayer film may be described as having the layers designated with letters. For example, a three layer structure having a core layer B, and two external layers A and C may be designated as A/B/C. Likewise, a structure having two core layers B and C and two external layers A and D would be designated A/B/C/D. Additionally, the skilled person would know that further layers E, F, G, etc. may also be incorporated into this structure.

Reference will now be made in detail to multilayer film embodiments of the present disclosure, wherein the multilayer film comprises at least a heat-resistant outer layer, a sealant layer, and a tie layer positioned between the outer layer and the sealant layer.

Heat-Resistant Outer Layer

In various embodiments, the outer layer includes one or more of a high density polyethylene (HDPE) having a density of greater than 0.945 g/cc and a polyethylene having a density of from 0.910 to 0.940 g/cc.

In one or more embodiments, the outer layer may include a first polyethylene having a density of greater than 0.945 g/cc, such as from 0.945 to 0.970 g/cc. In further embodiments, the first polyethylene may be a copolymer of ethylene and C₃-C₁₂ comonomer. Moreover, the melt flow rate (MFR) of the first ethylene may be from 0.3 to 6.0 g/10 min, from 0.3 to 5.0 g/10 min, from 0.3 to 4.0 g/10 min, from 0.3 to 3.0 g/10 min, from 0.3 to 2.0 g/10 min or from 0.3 to 1.5 g/10 min, or from 0.5 to 1.0 g/10 min. Various commercial products are considered suitable for the first polyethylene, for example, ELITE™ 5960G from The Dow Chemical Company (Midland, Mich.), or other HDPE products having a suitable density and MFR. Other suitable HDPEs include those described in PCT Publication No. WO 2017/099915, which is hereby incorporated by reference in its entirety.

In other embodiments, the outer layer additionally or alternatively includes a second polyethylene having a density of from 0.910 to 0.940 g/cc. Like the first polyethylene, the second polyethylene may be a copolymer of ethylene and C₃-C₁₂ comonomer. In further embodiments, the polyethylene may have a density of from 0.910 to 0.940 g/cc, from 0.925 to 0.945 g/cc, or from 0.925 to 0.935 g/cc. In further embodiments, the melt flow rate (MFR) may be from 0.3 to 4.0 g/10 min, from 0.3 to 3.0 g/10 min, from 0.5 to 2.0 g/10 min, or from 1.0 to 2.0 g/10 min. Various commercial products are considered suitable, for example, DOWLEX™ 2038.68 G from The Dow Chemical Company (Midland, Mich.), or other polyethylene products having a suitable density and MFR.

In some embodiments, the outer layer may be an oriented polyethylene film. For example, the outer layer may be biaxially oriented polyethylene (BOPE) or machine direction oriented (MDO) polyethylene. In embodiments in which the outer layer is BOPE, the BOPE may be biaxially oriented using a tenter frame sequential biaxial orientation process, and may referred to as tenter frame biaxially oriented polyethylene (TF-BOPE). Such techniques are generally known to those of skill in the art. In other embodiments, the polyethylene film can be biaxially oriented using other techniques known to those of skill in the art based on the teachings herein, such as double bubble or triple bubble orientation processes. In general, with a tenter frame sequential biaxial orientation process, the tenter frame is incorporated as part of a multilayer co-extrusion line. After extruding from a flat die, the film is cooled down on a chill roll, and is immersed into a water bath filled with room temperature water. The cast film is then passed onto a series of rollers with different revolving speeds to achieve stretching in the machine direction. There are several pairs of rollers in the MD stretching segment of the fabrication line, and are all oil heated. The paired rollers work sequentially as pre-heated rollers, stretching rollers, and rollers for relaxing and annealing. The temperature of each pair of rollers is separately controlled. After stretching in the machine direction, the film web is passed into a tenter frame hot air oven with heating zones to carry out stretching in the cross direction. The first several zones are for pre-heating, followed by zones for stretching, and then the last zones for annealing.

In some embodiments, the polyethylene film can be oriented in the machine direction at a draw ratio of 2:1 to 6:1, or in the alternative, at a draw ratio of 3:1 to 5:1. The polyethylene film, in some embodiments, can be oriented in the cross direction at a draw ratio of 2:1 to 9:1, or in the alternative, at a draw ratio of 3:1 to 8:1. In some embodiments, the polyethylene film is oriented in the machine direction at a draw ratio of 2:1 to 6:1 and in the cross direction at a draw ratio of 2:1 to 9:1.

Following biaxial orientation, the biaxially oriented polyethylene film can exhibit a number of physical properties. For example, in some embodiments, the biaxially oriented polyethylene film can exhibit an ultimate elongation in the machine direction that is at least 2 times greater than the ultimate elongation in the cross direction when measured according to ASTM D882, or in the alternative, at least 5 times greater, or in the alternative, at least 8 times greater, or in the alternative, at least 10 times greater.

In some embodiments, depending for example on the end use application, the biaxially oriented polyethylene film can be corona treated or printed using techniques known to those of skill in the art before or after lamination to the sealant film.

Tie Layer

In addition to the outer layer, the multilayer film further includes at least one tie layer. The tie layer serves to adhere the heat resistant outer layer to a sealant layer and/or other adjacent layers. In the case where the tie layer serves to adhere the outer layer to the sealant layer, the tie layer is adjacent to at least one sealant layer and the outer layer. In other words, the tie layer is sandwiched between the outer layer and the sealant layer.

The tie layer may include an adhesive resin selected from the group consisting of anhydride grafted ethylene-based polymer, ethylene acid copolymer, and ethylene vinyl acetate. Examples of anhydride grafting moieties may include but are not limited to, maleic anhydride, citraconic anhydride, 2-methyl maleic anhydride, 2-chloromaleic anhydride, 2,3-dimethylmaleic anhydride, bicyclo[2,2,1]-5-heptene-2,3-dicarboxylic anhydride and 4-methyl-4-cyclohexene-1,2-dicarboxylic anhydride, bicyclo(2.2.2)oct-5-ene-2,3-dicarboxylic acid anhydride, lo-octahydronaphthalene-2,3-dicarboxylic acid anhydride, 2-oxa-1,3-diketospiro(4.4)non-7-ene, bicyclo(2.2.1)hept-5-ene-2,3-dicarboxylic acid anhydride, tetrahydrophtalic anhydride, norbom-5-ene-2,3-dicarboxylic acid anhydride, nadic anhydride, methyl nadic anhydride, himic anhydride, methyl himic anhydride, and x-methyl-bi-cyclo(2.2.1)hept-5-ene-2,3-dicarboxylic acid anhydride. In one embodiment, the anhydride grafting moiety comprises maleic anhydride.

In some embodiments, the anhydride grafted ethylene-based polymer has a density from 0.86 to 0.96 g/cc, from 0.87 to 0.95 g/cc, or from 0.90 to 0.95 g/cc. In some embodiments, the anhydride grafted ethylene-based polymer has a melt flow rate from 0.1 g/10 min to 50 g/10 min, or from 0.5 g/10 min to 20 g/10 min, or from 1.0 g/10 min to 10 g/10 min.

Examples of commercially available anhydride grafted ethylene-based polymers that can be used in some embodiments include BYNEL™ 21E961 available from The Dow Chemical Company, Midland, Mich.

In some embodiments, the tie layer includes an ethylene acid copolymer. The ethylene acid copolymer is a polymerized reaction product of ethylene and one or more monocarboxylic acids. The monocarboxylic acid can be, for example, acrylic acid, methacrylic acid, or combinations thereof. In various embodiments, the monocarboxylic acid is present in an amount of from 1 wt % to 25 wt %, from 1 wt % to 20 wt %, or from 5 wt % to 15 wt % based on a total weight of the monomers present in the ethylene acid copolymer. In various embodiments, the ethylene content of the ethylene acid copolymer is greater than 50 wt %, or greater than 60 wt %. For example, the ethylene content of the ethylene acid copolymer is from 50 wt % to 95 wt %, from 50 wt % to 90 wt %, from 50 wt % to 85 wt %, or from 60 wt % to 80 wt %.

The ethylene acid copolymer has a density of from 0.905 to 0.940 g/cc, from 0.910 to 0.930 g/cc, or from 0.915 to 0.925 g/cc, in some embodiments. In embodiments, the ethylene acid copolymer has a MFR of from 9.0 g/10 min to 15 g/10 min, from 10.0 g/10 min to 12 g/10 min, or from 10.5 g/10 min to 11.5 g/10 min. In one particular embodiment, the ethylene acid copolymer is a terpolymer of ethylene, acrylic acid, and acrylate, wherein the acrylic acid may include methacrylic acid or acrylic acid and the acrylate may include isobutyl acrylate. In one or more embodiments, the ethylene acid copolymer may include an E/MAA copolymer (ethylene methacrylic acid), an E/AA copolymer (ethylene acrylic acid), or an E/MAA/iBA terpolymer (Ethylene Methacrylic acid and iso-butyl acrylate). Examples of suitable commercially available ethylene acid copolymers include NUCREL™ AE, NUCREL™ AN4228C, which are available from The Dow Chemical Company, Midland, Mich.

In still further embodiments, the tie layer includes an ethylene vinyl acetate. In some embodiments, the ethylene vinyl acetate has a MFR from 1 and 800 g/10 min, from 5 to 400 g/10 min, or from 5 to 150 g/10 min. In one or more embodiments, the ethylene vinyl acetate has a density of from 0.930 g/cc to 0.980 g/cc, from 0.940 g/cc to 0.970 g/cc, or from 0.950 g/cc to 0.960 g/cc. Examples of commercially available ethylene vinyl acetates that can be used in some embodiments include ELVAX™ 3175 available from The Dow Chemical Company, Midland, Mich.

In still further embodiments, the tie layer includes a random ethylene copolymer comprising a monomer of maleic anhydride in the polymer backbone or maleic anhydride grafted thereon. The ratio of ethylene copolymer may comprise from 0.1 wt. % to 2.0 wt. %, from 0.5 wt. % to 1.5 wt. %, from 0.75 wt. % to 1.25 wt. % of the monomer of maleic anhydride. The melt flow of the random ethylene polymer comprising a monomer of maleic anhydride may be from 1.0 g/10 min to 500 g/10 min, from 2.0 g/10 min to 400 g/10 min, from 5 g/10 min to 300 g/10 min, from 1.0 g/10 min to 200 g/10 min, from 100 g/10 min to 500 g/10 min, or from 200 g/10 min to 500 g/10 min. Examples of commercially available resins of random ethylene polymers comprising monomers of maleic anhydride which may be suitable for some embodiments include FUSABOND® M603 AND FUSABOND® M623 XF, which is commercially available from The Dow Chemical Company, Midland, Mich.

In still further embodiments, the tie layer may include a terpolymer of ethylene, acrylic ester and maleic anhydride. The terpolymer may include from 3 wt. % to 50 wt. %, from 3 wt. % to 40 wt. %, from 10 wt. % to 50 wt., from 10 wt. % to 40 wt. %, or from 20 wt. % to 30 wt. % of acrylic ester. The terpolymer may include from 0.1 wt. % to 5 wt. %, from 1 wt. % to 4 wt. %, or from 2 wt. % to 3 wt. % of maleic anhydride monomer. The terpolymer may have a melt flow rate of from 1 g/10 min to 400 g/10 min, from 10 g/10 min to 300 g/10 min, from 50 g/10 min to 300 g/10 min, or from 100 g/10 min to 200 g/10 min. Examples of commercially available terpolymers which may be suitable for some embodiments may include LOTADER 420 and LOTADER 4503, which are commercially available from Arkema.

In further embodiments, the tie layer includes a very low density polyethylene (VLDPE). The VLDPE has a density from 0.880 g/cc to 0.925 g/cc, from 0.900 g/cc to 0.920 g/cc, or from 0.900 g/cc to 0.910 g/cc. Examples of commercially available VLDPE that can be used in some embodiments include DOW DFDA 1086 NT, which is available from The Dow Chemical Company, Midland, Mich.

In further embodiments, the tie layer includes an elastomer compound, such as an ethylene propylene diene terpolymer. The elastomer compound may be present in the tie layer in an amount from 1 wt. % to 30 wt. %, from 5 wt. % to 25 wt. %, from 10 wt. % to 20 wt. %, or from 10 wt. % to 15 wt. %. Examples of commercially available elastomers which can be used in some embodiments include NORDEL IP 3722P, which is commercially available from The Dow Chemical Company, Midland, Mich.

In further embodiments, the tie layer may include an ethylene acrylate copolymer. Suitable acrylate copolymers may include ethyl methyl acrylate (EMA), ethylene ethyl acrylate (EEA), and ethylene butyl acrylate (EBA). The ethylene acrylate copolymer may have a comonomer level of maleic anhydride (MA), ethyl acrylate (EA) or butyl acrylate (BA) wt. % of from 5.0 wt. % to 50 wt. %, from 10 wt. % to 45 wt. %, from 15 wt. % to 40 wt. %, or from 20 wt. % to 35 wt. %. The ethylene acrylate copolymer may have a melt flow index of from 0.1 to 60 g/10 min, from 1 to 50 g/10 min, from 5 to 40 g/10 min, or from 10 to 30 g/10 min. Examples of commercially available copolymer resins which may be used in some embodiments include Elvaloy® 1224AC, Elvaloy® 1820AC, Elvaloy® 2618AC, Elvaloy® 3427AC, Elvaloy® 34035AC, which are all available from The Dow Chemical Company, Midland, Mich.

In some embodiments, the tie layer further includes at least one of a HDPE, linear low density polyethylene (LLDPE) or a low density polyethylene (LDPE). The HDPE, LLDPE or LDPE may be blended with the adhesive resin. In embodiments where LLDPE is included, LLDPE may help to provide enhanced mechanical performance (such as tear or dart) of the overall structure. In embodiments where HDPE is included, HDPE may help to provide enhanced stiffness. In embodiments where LDPE is included, LDPE may help provide improved blending properties, enhanced melt stability, and improved bubble stability. In such embodiments, the tie layer may include from 1 to 99% adhesive resin, from 10 to 60% adhesive resin, or from 20 to 40% adhesive resin based on a total weight of the tie layer. The tie layer may further include from 0 to 99% HDPE, LLDPE or LDPE, from 40 to 90% HDPE, LLDPE or LDPE, or from 60 to 80% HDPE, LLDPE to LDPE based on a total weight of the tie layer.

Additional compositions and additives are also contemplated to be included in the tie layer. For example, the tie layer may include tackifiers, such as rosins and their derivatives, terpenes and modified terpenes, aliphatic, cycloaliphatic and aromatic resins (C₅ aliphatic resins, C₉ aromatic resins, and C₅/C₉ aliphatic/aromatic resins), hydrogenated hydrocarbon resins and their mixtures, and terpene-phenol resins (TPR), which are used often with ethylene-vinyl acetate adhesives. One suitable hydrogenated hydrocarbon resin is Regalite R1125 available from Eastman Chemical.

Sealant Layer

The multilayer film of various embodiments further includes an inside surface, or sealant layer. This may be the inside layer of a package that is closest to the packaged contents. It also provides a means for sealing or closing the package around the packaged product, such as by heat sealing two portions of the sealant layer together or to the surface of another part of the package, such as sealing a lidding film to a thermoformed packaging component. The composition of the sealant layer is selected to influence the sealing capability of the inside surface layer, for example, to achieve a high sealing bond strength at the lowest possible sealing temperature.

The sealant layer may comprise one or more ethylene acid copolymers, a polyethylene plastomer having a density below 0.910 g/cc, and an ethylene-based polymer having a melting point Tm (DSC) of less than or equal to 108° C.

In one or more embodiments, the ethylene acid copolymers may be an ionomer having from 0.1 to 10.0 wt. % neutralized with a cation source may be referred to as ionomers. The ethylene acid copolymer is a polymerized reaction product of ethylene, a monocarboxylic acid, and a softening comonomer. The monocarboxylic acid can be, for example, acrylic acid, methacrylic acid, or combinations thereof. In various embodiments, the monocarboxylic acid is present in an amount of from 1 wt % to 25 wt %, from 1 wt % to 20 wt %, or from 5 wt % to 15 wt % based on a total weight of the monomers present in the ethylene acid copolymer. In various embodiments, the ethylene content of the ethylene acid copolymer is greater than 50 wt %, or greater than 60 wt %. For example, the ethylene content of the ethylene acid copolymer is from 50 wt % to 95 wt %, from 50 wt % to 90 wt %, from 50 wt % to 85 wt %, or from 60 wt % to 80 wt %.

In various embodiments, the ethylene acid copolymer includes a softening comonomer selected from the group consisting of vinyl esters, alkyl vinyl esters, and alkyl (meth)acrylates. The softening comonomer may be present in an amount from 1 wt % to 40 wt % or 1 wt % to 30 wt %, based on the total weight of the monomers present in the ethylene acid copolymer. In some embodiments, the softening comonomer is alkyl acrylate. Suitable examples of alkyl acrylates include, but are not limited to, ethyl acrylate, methyl acrylate, n-butyl acrylate, iso-butyl acrylate, or combinations thereof. In various embodiments, the alkyl acrylate has an alkyl group with from 1 to 8 carbons.

The ethylene acid copolymer can be prepared by standard free-radical copolymerization methods, using high pressure, operating in a continuous manner. Monomers are fed into the reaction mixture in a proportion which relates to the monomer's activity, and the amount desired to be incorporated. In this way, uniform, near-random distribution of monomer units along the chain is achieved. Unreacted monomers may be recycled. Additional information on the preparation of ethylene acid copolymers including the softening copolymer can be found in U.S. Pat. Nos. 3,264,272 and 4,766,174, each of which is hereby incorporated by reference in its entirety.

As stated above, the ethylene acid copolymer can be used to produce ionomers by treatment with a cation source. The cation source may be a mono- or divalent cation source, including but not limited to formates, acetates, hydroxides, nitrates, carbonates, and bicarbonates. In various embodiments, the ethylene acid copolymer can be treated with one or more cations or cation sources which may comprises magnesium, sodium, zinc, or combinations thereof. In one or more embodiments, the ionomer may having from 0.1 to 10.0 wt. % from 1.0 to 10.0 wt. %, from 1.0 to 8.0 wt. %, or from 1.0 to 5.0 wt. % neutralized with a cation source.

In some embodiments, the ionomer has a density of from 0.930 g/cc to 0.980 g/cc, from 0.940 g/cc to 0.970 g/cc, or from 0.950 g/cc to 0.960 g/cc. In one or more embodiments, the ionomer has a MFR of from 2 g/10 min to 12 g/10 min, from 3.5 g/10 min to 10 g/10 min, or from 5 g/10 min to 8 g/10 min. Commercially available ionomers include those available under the tradename SURLYN™ from The Dow Chemical Company, Midland, Mich.

In the context of this disclosure, the percent neutralization data is presented using the assumption that each cation will react with the maximum number of carboxylic acid groups calculated from its ionic charge. That is, it is assumed, for example, that Mg²⁺ and Zn²⁺ will react with two carboxylic acid groups and that Na⁺ will react with one.

In some embodiments, the sealant layer includes a linear low density polyethylene plastomer. Polyethylene polymers may include resins made using single-site catalysts such as metallocenes and constrained geometry catalysts. The polyethylene plastomer has a density below 0.910 g/cc. The density may be, for example, from 0.885 to 0.910 g/cc, from 0.895 to 0.910 g/cc, from 0.900 to 0.910 g/cc, or 0.905 to 0.910 g/cc. In some embodiments, the polyethylene plastomer has a density from 0.885 to 0.907 g/cc.

In some embodiments, the polyethylene plastomer has a melt flow rate (MFR) of up to 20 g/10 minutes. All individual values and subranges up to 20 g/10 minutes are included herein and disclosed herein. For example, the polyethylene plastomer can have a melt index to an upper limit of 1.0, 2.0, 3.0, 4.0, 5.0, 6.0, 7.0, 8.0, 9.0, 10.0, 11, 12, 13, 14, 15, 16, 17, 18, 19, or 20 g/10 minutes. In a particular aspect of the invention, the polyethylene plastomer has an MFR with a lower limit of 0.5 g/10 minutes. One factor in identifying a melt index for the polyethylene plastomer is whether the sealant layer will be manufactured as a blown film or a cast film.

Examples of polyethylene plastomers that can be used in the sealant layer include those commercially available from The Dow Chemical Company under the name AFFINITY™ including, for example, AFFINITY™ PF7266, AFFINITY™ PL 1881G and AFFINITY™ PF1140G.

In still other embodiments, the sealant layer includes an ethylene-based polymer having a melting point Tm (DSC) of less than or equal to 108° C. In some embodiments, the ethylene-based polymer is a linear low density polyethylene (LLDPE). The linear low density polyethylene has a density less than or equal to 0.930 g/cc (cm³). All individual values and subranges less than or equal to 0.930 g/cc are included herein and disclosed herein; for example, the density of the linear low density polyethylene can be from an upper limit of 0.928, 0.925, 0.920 or 0.915 g/cc. In some embodiments, the linear low density polyethylene has a density greater than or equal to 0.870 g/cc. All individual values and subranges between 0.870 and 0.930 g/cc are included herein and disclosed herein.

The ethylene-based polymer has a peak melting point of 108° C. or less in some embodiments, preferably between 70 and 108° C., more preferably between 70 and 99° C.

The melt index of the ethylene-based polymer in the sealant layer can depend on a number of factors including whether the film is a blown film or a cast film. In embodiments where the film is a blown film, the ethylene-based polymer has an MFR of less than or equal to 2.0 g/10 minutes. All individual values and subranges from 2.0 g/10 minutes are included herein and disclosed herein. For example, the ethylene-based polymer can have a melt index from an upper limit of 2.0, 1.7, 1.4, 1.1, or 0.9 g/10 minutes or a lower limit of 0.1, 0.2, 0.3, or 0.4 g/10 minutes.

In other embodiments, the film can be a cast film. In such embodiments, the ethylene-based polymer has an MFR greater than or equal to 2.0 g/10 minutes. All individual values and subranges above 2.0 g/10 minutes are included herein and disclosed herein. For example, the ethylene-based polymer can have a melt index from a lower limit of 2.0, 3.0, 4.0, 5.0, 6.0, or 10 g/10 minutes. In some embodiments, the ethylene-based polymer for a cast film application can have an upper melt index limit of 15 g/10 minutes. In some embodiments, depending on the other components in the multilayer film, the ethylene-based polymer in the sealant layer for a cast film application can have an upper limit of MFR of less than 2.0 g/10 minutes. In some embodiments, the ethylene-based polymer in the sealant layer for a cast film application can have a melt flow rate (MFR) of from 0.1 to 2.0 g/10 minutes, or from 0.5 to 2.0 g/10 minutes. All individual values and subranges from 0.1 to 2.0 g/10 minutes are included herein and disclosed herein.

Examples of ethylene-based polymer that can be used in the sealant layer include those commercially available from The Dow Chemical Company under the names ELITE™ AT including, for example, ELITE™ AT 6101, ELITE™ AT 6202, ELITE™ AT 6410.

Multilayer Films

The multilayer films may be formed and oriented (for example, biaxially oriented) by any suitable process. Information about these processes may be found in reference texts such as, for example, the Kirk Othmer Encyclopedia, the Modern Plastics Encyclopedia, or the Wiley Encyclopedia of Packaging Technology, 2d edition, A. L. Brody and K. S. Marsh, Eds., Wiley-Interscience (Hoboken, 1997). For example, the multilayer films may be formed through dipcoating, film casting, sheet casting, solution casting, compression molding, injection molding, lamination, melt extrusion, blown film including circular blown film, extrusion coating, tandem extrusion coating, or any other suitable procedure. In some embodiments, the films are formed by a melt extrusion, melt coextrusion, melt extrusion coating, or tandem melt extrusion coating process. In some embodiments, the films are formed by thermal lamination or extrusion lamination and coating. Suitable orientation processes include tenter frame technology and machine-direction orientation (MDO) technology. When a layer of the multilayer film, such as the outer layer, is an oriented film, it can be laminated to the sealant layer by the tie layer using techniques known to those having ordinary skill in the art based on the teachings herein.

Optionally, in some embodiments, the multilayer structure may include one or more additional layers, such as one or more core layers and one or more additional tie layers. For example, such additional layers may be positioned between the outer layer and the sealant layer. In one particular embodiment, the multilayer structure may include an outer layer, a core layer, a tie layer, and a sealant layer, and the tie layer is disposed between the core layer and the sealant layer. In some other embodiments, the multilayer structure may include an outer layer, a first tie layer, a core layer, a second tie layer, and a sealant layer, wherein the first tie layer is disposed between the outer layer and the core layer, and the second tie layer is disposed between the core layer and the sealant layer. In some of such embodiments, the outer layer may include an HDPE, and the core layer may include a biaxially oriented polyethylene (BOPE) having a density of from 0.910 to 0.940 g/cc. Other constructions are contemplated.

Moreover, in further embodiments, the multilayer film structures consist essentially of ethylene-based polymers. As used herein, “consists essentially” means that the multilayer film structure may include other additives but is limited to ethylene-based polymer.

It should be understood that any of the layers within a multilayer film of the various embodiments described herein can further comprise one or more additives as known to those of skill in the art such as, for example, antioxidants, ultraviolet light stabilizers, thermal stabilizers, slip agents, antiblock, pigments or colorants, processing aids, crosslinking catalysts, flame retardants, fillers and foaming agents.

In various embodiments described herein, the multilayer film is a laminate free of solvent-based adhesives, solventless adhesives, and water-borne laminating adhesives. As described above, the multilayer films described herein are imparted with a unique combination of heat resistance, high stiffness, and gloss without the use of adhesives.

In various embodiments, the multilayer film may have a shrinkage of less than 10%, 7.5%, or even 5% in the transverse direction and/or a shrinkage of less than 15%, 12%, or even 10% in the machine direction at 125° C.

In various embodiments, the multilayer film exhibits a seal strength of 25 N/25 mm or greater at 125° C. For example, the multilayer film may have a seal strength of greater than 25 N/25 mm, greater than 30 N/25 mm, greater than 32 N/25 mm, or greater than 35 N/25 mm. The multilayer film, in some embodiments, may have a seal strength of from 25 N/25 mm to 55 N/25 mm, from 25 N/25 mm to 50 N/25 mm, from 30 N/25 mm to 55 N/25 mm, from 30 N/25 mm to 50 N/25 mm, from 32 N/25 mm to 55 N/25 mm, from 32 N/25 mm to 50 N/25 mm, from 35 N/25 mm to 55 N/25 mm, or even from 35 N/25 mm to 50 N/25 mm.

Various multilayer films described herein further exhibit a heat seal initiation temperature (HSIT) of less than 120° C. at a load of 5 N. For example, the multilayer film may exhibit a HSIT of less than 120° C., less than 115° C., less than 110° C., or less than 100° C. In some embodiments, the multilayer film exhibits a HSIT of from 80° C. to 120° C., from 82° C. to 120° C., from 85° C. to 120° C., or from 85° C. to 115° C.

In various embodiments, the multilayer film exhibits a gloss at 45° of greater than 25, as measured in accordance with ASTM D2457-08/ASTM D1003-01. For example, the multilayer film may exhibit a gloss at 45° of 25 to 75, 25 to 70, 30 to 75, 30 to 70, 35 to 75, 35 to 70, 40 to 75, 40 to 70, 45 to 75, or 45 to 70. In some other embodiments, the multilayer film may exhibit a gloss at 45° of 25 to 65, 25 to 60, 25 to 55, 25 to 50, 30 to 65, 30 to 60, 30 to 55, 30 to 50, 35 to 65, 35 to 60, 35 to 55, or 35 to 50.

Articles

In various embodiments, the multilayer films disclosed herein can be used to form articles such as packages. Such articles can be formed from any of the multilayer films described herein. Examples of packages that can be formed from multilayer films of various embodiments can include flexible packages, sachets, pouches, stand-up pouches, and pre-made packages or pouches. In some embodiments, multilayer films described herein can be used for food packages, such as packages for meats, cheeses, cereal, nuts, juices, sauces, and the like. Such packages can be formed using techniques known to those of skill in the art based on the teachings herein and based on the particular use for the package (e.g., type of food, amount of food, etc.).

### Testing Methods

The test methods include the following:

Melt Flow Rate (MFR)

Melt flow rate (MFR) were measured in accordance with ASTM D-1238 at 190° C. at 2.16 kg. The values are reported in g/10 min, which corresponds to grams eluted per 10 minutes.

Heat Seal Strength

Heat seal strength, or seal strength was measured in accordance with ASTM F1921. The values are reported in N/25 mm.

Shrinkage

Shrinkage was obtained by measuring the length and width of the seal area in both MD and TD directions after heat sealing the films together and calculating the percentage of change compared to the seal bar width, which can be between 1 mm to 15 mm. Standard heat sealing machines, including PULSA impulse sealer or J&B Hot Tack tester can be used, provided the machines have an accurate and adjustable temperature controller. Sealing conditions include jaw pressure (40-80 psi or 0.275-0.552 N/mm²), dwell time (0.1-1.5 seconds), and seal temperature (60-150° C.) window and depend on packaging speed, where typical conditions for fast speed packaging machines are 40 psi (0.275 N/mm²) jaw pressure and 0.5 seconds dwell time.

Gloss

The gloss at 45° was measured in accordance with ASTM D2457-08/ASTM D1003-01.

Haze

Haze was measured in accordance with ASTM D1003-01.

Bond Strength

Bond strength was measured using a Zwick tensile tester at a pulling speed of 250 mm/min and with 25 mm width strips. The tensile tester is equipped with a gripper fixture (sample held in a T-shape) to hold two ends of a partially delaminated or partially peeled sample before being pulled apart. The upper gripper that is connected to the crosshead is driven in the tensile direction to measure the force required or bond strength between two adjacent layers of the multilayer sample. Maximum force and average force results are calculated from 5 measurements and recorded in Newtons (N/25 mm strips) units.

Density

Samples for density measurement were prepared according to ASTM D4703 and reported in grams/cubic centimeter (g/cc or g/cm³). Measurements were made within one hour of sample pressing using ASTM D792, Method B.

Melting Point

Differential Scanning calorimetry (DSC) is used to measure the melting and crystallization behavior of a polymer over a wide range of temperatures. For example, the TA Instruments Q1000 DSC, equipped with an RCS (refrigerated cooling system) and an autosampler is used to perform this analysis. The instrument is first calibrated using the software calibration wizard. A baseline is obtained by heating a cell from −80° C. to 280° C. without any sample in an aluminum DSC pan. Sapphire standards are then used as instructed by the calibration wizard. Next, 1 to 2 milligrams (mg) of a fresh indium sample are analyzed by heating the standards sample to 180° C., cooling to 120° C. at a cooling rate of 10° C./minute, and then keeping the standards sample isothermally at 120° C. for 1 minute. The standards sample is then heated from 120° C. to 180° C. at a heating rate of 10° C./minute. Then, it is determined that indium standards sample has heat of fusion (H_{f})=28.71±0.50 Joules per gram (J/g) and onset of melting=156.6° C.±0.5° C. Test samples are then analyzed on the DSC instrument.

During testing, a nitrogen purge gas flow of 50 ml/min is used. Each sample is melt pressed into a thin film at about 175° C.; the melted sample is then air-cooled to room temperature (approx. 25° C.). The film sample is formed by pressing a “0.1 to 0.2 gram” sample at 175° C. at 1,500 psi, and 30 seconds, to form a “0.1 to 0.2 mil thick” film. A 3-10 mg, 6 mm diameter specimen is extracted from the cooled polymer, weighed, placed in a light aluminum pan (ca 50 mg), and crimped shut. Analysis is then performed to determine its thermal properties.

The thermal behavior of the sample is determined by ramping the sample temperature up and down to create a heat flow versus temperature profile. First, the sample is rapidly heated to 180° C., and held isothermal for five minutes, in order to remove its thermal history. Next, the sample is cooled to −40° C., at a 10° C./minute cooling rate, and held isothermal at −40° C. for five minutes. The sample is then heated to 150° C. (this is the “second heat” ramp) at a 10° C./minute heating rate. The cooling and second heating curves are recorded. The cool curve is analyzed by setting baseline endpoints from the beginning of crystallization to −20° C. The heat curve is analyzed by setting baseline endpoints from −20° C. to the end of melt. The values determined are peak melting temperature (Tₘ), peak crystallization temperature (T_{c}), onset crystallization temperature (Tc onset), heat of fusion (H_{f}) (in Joules per gram), and the calculated % crystallinity for polyethylene samples using: % Crystallinity for PE=((Hf)/(292 J/g))×100, and the calculated % crystallinity for polypropylene samples using: % Crystallinity for PP=((Hf)/165 J/g))×100. The heat of fusion (H_{f}) and the peak melting temperature are reported from the second heat curve. Peak crystallization temperature and onset crystallization temperature are determined from the cooling curve.

Elongation at Break

Tensile strength values for elongation at break are measured in the machine direction (MD) with a ZWICK model Z010 with TestXpertII software according to ASTM D882.

### Examples

The following examples illustrate features of the present disclosure but are not intended to limit the scope of the disclosure.

Polymers/Film Used

The following compositions and film listed in Table 1 were included in the multilayer examples discussed below. All materials were obtained from The Dow Chemical Company (Midland, Mich.).

TABLE 1

| | Melt Flow | | |
|---|---|---|---|
| | Rate (MFR) | Density | |
| Material | g/10 min | (g/cc) | Description |
| ELITE ™ 5960G | 0.85 | 0.962 | First polyethylene |
| DOWLEX ™ 2038.68G | 1.0 | 0.935 | MDPE |
| TF-BOPE | 1.7 | 0.926 | LLDPE biaxially oriented film |
| | | | (stretched by tenter frame)* |
| BYNEL ™ 21E961 | 1.9 | 0.949 | Anhydride-modified |
| | | | ethylene acrylate |
| ELVAX ™ 3175 | 6.0 | 0.950 | Ethylene-vinyl acetate (EVA) |
| NUCREL ™ AE | 11 | 0.920 | Terpolymer of ethylene, MAA, and |
| | | | acrylate |
| SURLYN ™ 1705-1 | 5.5 | 0.950 | Zinc ionomer of ethylene methacrylic |
| | | | acid copolymer** |
| SURLYN ™ 1605SBR | 3.0 | 0.950 | Sodium ionomer of ethylene |
| | | | methacrylic acid copolymer** |
| AFFINITY ™ PF 7266 | 2.5 | 0.885 | Polyethylene plastomer |

*This LLDPE corresponds to the 2nd PE Composition described in PCT Publication WO2018/048580, which is incorporated by reference. The biaxially oriented LLDPE was stretched in the machine direction at a draw ratio of 3-5X and in the cross direction at a draw ratio of 7-9X.
**Both SURLYN formulations have between 0.1 to 10 wt. % neutralized by a cation source (zinc or sodium)

The following multilayer films of Table 2 had an ABCBD 5 layer structure or an ABD 3 layer structure produced through thermal lamination. The thermal lamination was performed on a ChemInstruments #007416 hot roll lamination machine at the conditions provided in Table 2, where T is temperature and P is pressure.

TABLE 2
Film Samples 1-4 and Comparative Film Samples C1-C2

| Sample | | | | | | Thickness | T | P | Speed |
|---|---|---|---|---|---|---|---|---|---|
| # | Layer A | Layer B | Layer C | Layer B | Layer D | (μm) | (° C.) | (psi) | (m/min) |
| C1 | BOPP18*** | BYNEL ™ | printed | BYNEL ™ | SURLYN ™ | 208 | 180 | 60 | 0.75 |
| | | 21E961 | TF-BOPE | 21E961 | 1705-1 | | | | |
| C2 | BOPP18*** | ELVAX ™ | TF-BOPE | ELVAX ™ | SURLYN ™ | 208 | 160 | 60 | 0.75 |
| | | 3175 | | 3175 | 1705-1 | | | | |
| 1 | ELITE ™ | BYNEL ™ | printed | BYNEL ™ | SURLYN ™ | 240 | 180 | 60 | 0.75 |
| | 5960G | 21E961 | TF-BOPE | 21E961 | 1705-1 | | | | |
| 2 | ELITE ™ | ELVAX ™ | TF-BOPE | ELVAX ™ | SURLYN ™ | 240 | 160 | 60 | 0.75 |
| | 5960G | 3175 | | 3175 | 1705-1 | | | | |
| 3 | printed | BYNEL ™ | | | SURLYN ™ | 140 | 140 | 60 | 0.75 |
| | TF-BOPE | 21E961 | | | 1705-1 | | | | |
| 4 | TF-BOPE | ELVAX ™ | | | SURLYN ™ | 140 | 130 | 60 | 0.75 |
| | | 3175 | | | 1705-1 | | | | |

***BOPP18 is an unprinted, 18 micron gauge, biaxially oriented polypropylene treated at 36 dynes.

Referring to Table 3, additional multilayer films were produced on a 5 Layer Collin Coextrusion Blown Film Line in accordance with the following parameters provided in Table 4.

TABLE 3
Film Samples 5 and 6

| Sample | | | |
|---|---|---|---|
| # | Layer A | Layers B and C | Layer D |
| 5 | ELITE ™ 5960G | 80% DOWLEX ™ | SURLYN ™ 1605SBR |
| | | 2038.68G + 20% | |
| | | NUCREL ™ AE | |
| 6 | ELITE ™ 5960G | 80% DOWLEX ™ | 94% AFFINITY PF 7266 + 5% |
| | | 2038.68G + 20% | Anti-block additive + 1% |
| | | NUCREL ™ AE | slip additive**** |

****AB-Polybatch AB5 (anti-block additive) + slip = Polybatch CE505 (slip additive)

TABLE 4
Film Fabrication Conditions

| Thickness | 110 μm |
|---|---|
| Extruders | 4 extruders |
| Layer Configuration | A/B/C/B/D |
| Layer Ratio | 18.2%/13.6%/36.3%/13.6%/18.2% |
| Layer Thickness (μm) | 20/15/40/15/20 |

The heat seal strength, shrinkage, heat seal initiation temperature (HSIT), haze, and gloss for Comparative Samples 1 and 2 and Samples 1-6 were measured and are reported in Table 5.

TABLE 5
Summary of Testing Results

| | Shrinkage | | Seal | | |
|---|---|---|---|---|---|
| | (%) | | Strength | | |
| Sample | MD/TD at | HSIT (° C.) | (N/25 mm) | Haze | Gloss at |
| # | 125° C. | at 5 N | at 125° C. | (%) | 45° |
| C1 | 0/0 | 116 | 37.18 | 89.6% | 50.5 |
| | | | | (printed) | |
| C2 | 0/0 | 108 | 41.08 | 35.4% | 64.2 |
| 1 | 5/0 | 118 | 35.88 | 92.5% | 25.2 |
| | | | | (printed) | |
| 2 | 0/0 | 114 | 43.55 | 11.4% | 35.7 |
| 3 | 10/5 | 96 | 40.95 | 73.7% | 48.4 |
| | | | | (printed) | |
| 4 | 5/5 | 96 | 35.36 | 10.5% | 68.5 |
| 5 | 0/0 | 88 | 36.45 | 13.9% | — |
| 6 | 0/0 | 85 | 49.03 | 13.5% | — |

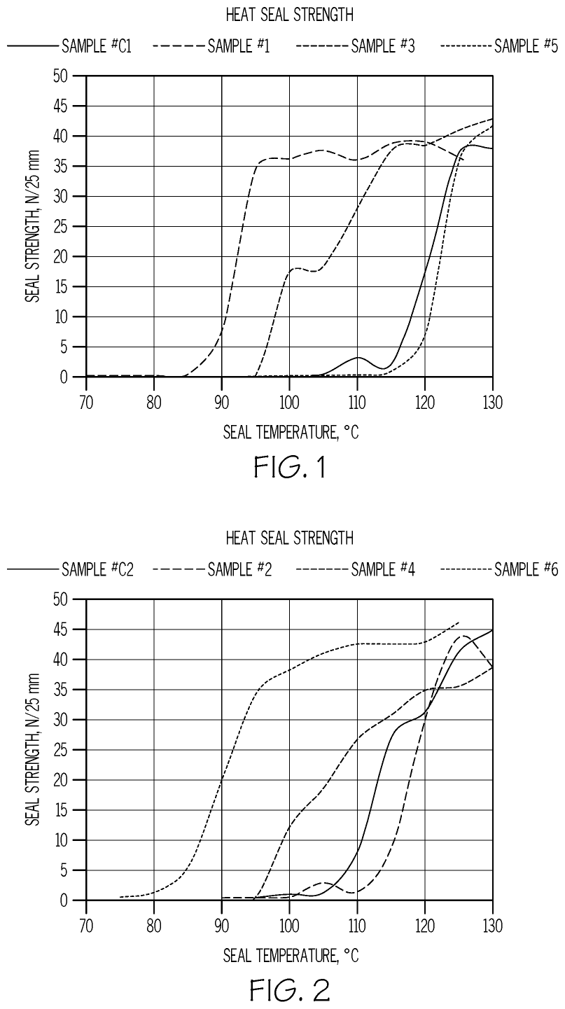

As demonstrated by the data in Table 5, Samples 1 and 2, using ELITE™ 5960 G were able to achieve HSIT performance and no shrinkage up to 130° C., similar to the Comparative Samples using BOPP. Samples 3-6, which included a strategic selection of low Tm sealant materials, tie layer adhesive resins, and film structural design, demonstrate a significant enhancement of HSIT, up to 25° C. lower than the comparative samples. The decreased HSIT performance makes the multilayer films suitable for high form-fill-seal packaging (FFS) line speeds or packaging machines. Additionally, Samples 1-6 demonstrate that all-polyethylene films are able to seal at low temperatures and do not have delamination between the layers despite the absence of laminating adhesives in the film structures. The heat seal strength curves of FIGS. 1 and 2 depicts the heat seal performance of Samples 1-6 and Comparative Samples 1 and 2.

The data in Table 5 further demonstrates excellent resistance to shrinkage (<5%) measured at the heat seal area. Moreover, the haze and gloss performance of Samples 1-6 is excellent compared to the BOPP-containing comparative samples, confirming that the multilayer films described herein are suitable for printed, non-printed, and/or high clarity films with no picture distortions during pouch forming and heat sealing processes.

The bond strength of Comparative Samples 1 and 2 and Samples 1˜4 were measured, and the results are reported in Table 6.

TABLE 6
Bond Strength Testing Results

| | | Bond |
|---|---|---|
| Sample | Bond strength measured | strength |
| # | between/****/layers | (N/25 mm) |
| C1 | BOPP/****/BYNEL ™ 21E961 | 2.1 |
| | BYNEL ™ 21E961/****/printed TF-BOPE | 7.2 |
| | Printed TF-BOPE/****/BYNEL ™ 21E961 | 18.3 |
| | BYNEL ™ 21E961/****/SURLYN ™ 1705-1 | 6.3 |
| C2 | BOPP/****/ELVAX ™ 3175 | 1.3 |
| | ELVAX ™ 3175/****/TF-BOPE | 2.9 |
| | TF-BOPE/****/ELVAX ™ 3175 | 16.0 |
| | ELVAX ™ 3175/****/SURLYN ™ 1705-1 | 9.6 |
| 1 | ELITE ™ 5960G /****/BYNEL ™ 21E96 | 15.5 |
| | BYNEL ™ 21E961/****/printed TF-BOPE | 3.7 |
| | Blue ink Transparent area | 7.5 |
| | Printed TF-BOPE/****/BYNEL ™ 21E961 | 19.3 |
| | BYNEL ™ 21E961/****/SURLYN ™ 1705-1 | 9.0 |
| 2 | ELITE ™ 5960G/****/ELVAX ™ 3175 | 15.0 |
| | ELVAX ™ 3175/****/TF-BOPE | 6.6 |
| | TF-BOPE/****/ELVAX ™ 3175 | 12.6 |
| | ELVAX ™ 3175/****/SURLYN ™ 1705-1 | 15.3 |
| 3 | Printed TF-BOPE/****/BYNEL ™ 21E961 | 19.5 |
| | BYNEL ™ 21E961/****/SURLYN ™ 1705-1 | 5.4 |
| 4 | TF-BOPE/****/ELVAX ™ 3175 | 17.5 |
| | ELVAX ™ 3175/****/SURLYN ™ 1705-1 | 10.2 |

As shown in Table 6, each of Samples 1˜4 achieved greater than 5.4 N/25 mm adhesion to the outer and sealant layers, and only slightly lower adhesion (greater than 3.7 N/25 mm) to the ink layers, which is still more than acceptable. These results confirm that no delamination occurs between the film layers and, therefore, thermal lamination, extrusion lamination, and blown/cast film co-extrusion are effective methods for fabrication of films and laminates without the use of solvent, solventless, or water-borne laminating adhesives.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

1. A multilayer film comprising:
an outer layer comprising a first polyethylene having a density of greater than 0.945 g/cc;
a sealant layer comprising one or more of: at least one ethylene acid copolymer having from 0.1 to 10 wt % neutralized with a cation source; a polyethylene plastomer having a density below 0.910 g/cc; and an ethylene based polymer having a melting point Tm (DSC) less than or equal to 108° C.;
a tie layer positioned between the outer layer and the sealant layer, the tie layer comprising a polymer selected from the group consisting of anhydride grafted ethylene based polymer, ethylene acid copolymer, and ethylene vinyl acetate; and
a core layer comprising biaxially oriented polyethylene having a density from 0.910 to 0.940 g/cc, wherein the tie layer is disposed between the core layer and the sealant layer.

2. (canceled)

3. The multilayer film according to claim 1, wherein the multilayer film further comprises a second tie layer disposed between the core layer and the outer layer.

4. The multilayer film of claim 1, wherein the tie layer further comprises at least one of linear low density polyethylene (LLDPE) or low density polyethylene (LDPE).

5. The multilayer film of claim 1, wherein the multilayer film is a blown film or cast film.

6. The multilayer film of claim 1, wherein the multilayer film is formed by thermal lamination or by extrusion lamination and coating.

7. The multilayer film according to claim 1, wherein the outer layer comprises a biaxially oriented polyethylene (BOPE) film or a machine-direction oriented polyethylene (MDO) film.

8. The multilayer film according to claim 1, wherein the outer layer comprises medium density polyethylene (MDPE).

9. The multilayer film of claim 1, wherein the ethylene-based polymer of the sealant layer has a Tm (DSC) of greater than 70° C. and less than 99° C.

10. The multilayer film of claim 1, wherein the multilayer film is a laminate free of solvent-based adhesives, solventless adhesives, and water-borne laminating adhesives.

11. The multilayer film of claim 1, wherein the multilayer film exhibits a shrinkage of less than 5% in the transverse direction at 125° C., 40 PSI, and 0.5 seconds dwell time.

12. The multilayer film of claim 1, wherein the multilayer film exhibits a shrinkage of less than 10% in the machine direction at 125° C., 40 PSI, and 0.5 seconds dwell time.

13. The multilayer film of claim 1, wherein the multilayer film exhibits a seal strength of 25 N/25 mm or greater at 125° C. as measured in accordance with ASTM F1921.

14. The multilayer film of claim 1, wherein the multilayer film exhibits a Heat Seal Initiation Temperature (HSIT) of less than 120° C. at a load of 5 N.

15. The multilayer film of claim 1, wherein the multilayer film exhibits a gloss at 45° of greater than 25, as measured in accordance with ASTM D2457-08/ASTM D1003-01.

16. The multilayer film of claim 1, wherein the sealant layer comprises at least one ethylene acid copolymer having from 0.1 to 10 wt. % neutralized with the cation source.

17. The multilayer film of claim 1, wherein the cation source comprises sodium salt, zinc salt, or combinations thereof.

18. The multilayer film of claim 1, further comprising a print layer.

19. An article comprising the multilayer film of claim 1, wherein the article is a pouch.
